(19) United States
(12) Patent Application Publication
(10) Pub. No.: US 2019/0204794 A1
(43) Pub. Date: Jul. 4, 2019

(54) OPTIMIZATION APPARATUS AND OPTIMIZATION APPARATUS CONTROL METHOD

(71) Applicant: FUJITSU LIMITED, Kawasaki-shi (JP)

(72) Inventors: Satoshi MATSUBARA, Machida (JP); Motomu TAKATSU, Shinjuku (JP)

(73) Assignee: FUJITSU LIMITED, Kawasaki-shi (JP)

(21) Appl. No.: 16/194,713

(22) Filed: Nov. 19, 2018

(30) Foreign Application Priority Data
Dec. 29, 2017 (JP) 2017-255104

(51) Int. Cl. G05B 13/02; G06F 17/11; G06F 17/50

(52) U.S. Cl. CPC G05B 13/021; G06F 17/5009; G06F 17/11

(57) ABSTRACT

An optimization apparatus includes: a state retention unit configured to retain a set of values of state variables for an evaluation function representing energy; a first evaluation function calculation unit configured to calculate an energy value of a first evaluation function including a first penalty coefficient; a transition control unit configured to determine whether or not a state transition for changing one of the values of the state variables is to be accepted stochastically, based on at least a variation of the energy value of the first evaluation function; a second evaluation function calculation unit configured to calculate an energy value of a second evaluation function including a second penalty coefficient larger than the first penalty coefficient; and an energy comparing unit configured to determine a minimum energy value of the energy value of the first evaluation function or the second evaluation function.

### CROSS-REFERENCE TO RELATED APPLICATION

This application is based on and claims priority to Japanese Patent Application No. 2017-255104, filed on Dec. 29, 2017, the entire contents of which are incorporated herein by reference.

### FIELD

The embodiments discussed herein relate to an optimization apparatus and a method of controlling the optimization apparatus.

### BACKGROUND

Simulated annealing is known as a method of solving a combinatorial optimization problem. For example, with respect to an evaluation function (energy function) which is a target of optimization, an optimization apparatus searches for an optimal solution for minimizing a value (an output) of the evaluation function, by using the simulated annealing. When a combinatorial optimization problem including a constraint is to be solved, an evaluation function including a term (penalty term) which becomes positive when the constraint is not satisfied is used. A weight of the constraint is represented by a coefficient (penalty coefficient) of the term representing the constraint, for example.

If the penalty coefficient is set smaller, a solution not satisfying a constraint is likely to be obtained. Conversely, if the penalty coefficient is set larger, state transition is less likely to occur because an energy barrier that needs to be overcome for state transition becomes higher. That is, a probability that only a solution that makes an output of the evaluation function large is obtained becomes larger. To avoid the problem, a technique for estimating an appropriate penalty coefficient is proposed (see Patent Document 1 and Patent Document 2, for example). In the technique, when solving a combinatorial optimization problem, by changing magnitude of a penalty coefficient in an evaluation function dynamically, searching of an optimal solution is performed while estimating an appropriate magnitude of the penalty coefficient.

With respect to the problem of the above mentioned penalty coefficient, a case in which an Ising-like evaluation function is used will be described below.

In a case in which an Ising model representing behavior of spins of a magnetic body is used as an evaluation function, an optimization apparatus searches for an optimal solution that minimizes an energy value (an output value of the evaluation function), by changing state variables included in the evaluation function one by one. For example, the optimization apparatus calculates a variation of the energy value in accordance with state transition in which a value of only one of the state variables is changed, and stochastically determines whether or not the state transition is to be accepted, based on the variation. By state transition being repeated, an optimal solution or an approximate solution having an energy value close to an energy value of an optimal solution can be obtained.

Generally, an evaluation function for a discrete optimization problem has a large number of local solutions each corresponding to a local minimum, in addition to an optimal solution that minimizes a value (an output) of the evaluation function. When repeating state transition in which a value of only one of the state variables is changed, during an optimization process, the process may reach a solution not satisfying a constraint. That is, state transition from a local solution to a solution not satisfying a constraint may occur during the optimization process. In a case in which a penalty coefficient is large, the state transition from a local solution to a solution not satisfying a constraint is less likely to occur, as compared to a case in which a penalty coefficient is small. However, as it takes time to escape from the local solution, speed of optimization becomes lower. Conversely, if a penalty coefficient is small, when a solution not satisfying a constraint is input to an evaluation function, a value (output) of the evaluation function may become smaller than a value of the evaluation function when an optimal solution is input. Thus, there is a risk in which a solution not satisfying a constraint is output as an optimal solution.

In the above, a case in which an Ising-like evaluation function is used as an evaluation function and in which only one of state variables is changed at a time is described. However, a similar problem may occur when other evaluation functions are used or when multiple state variables are changed at a time.

Although the above mentioned related art can partly alleviate the above problem, a complex control is required for changing a penalty coefficient dynamically.

The following is reference documents:
[Patent Document 1] Japanese Laid-Open Patent Publication No. 05-120252
[Patent Document 2] Japanese Laid-Open Patent Publication No. 03-167655

### SUMMARY

In one aspect, an optimization apparatus includes: a state retention unit configured to retain state variables for a first evaluation function and a second evaluation function each representing energy, the first evaluation function including a first penalty coefficient and the second evaluation function including a second penalty coefficient larger than the first penalty coefficient; a first evaluation function calculation unit configured to calculate an energy value of the first evaluation function after a state transition in which a value of one of the state variables is changed; a temperature control unit configured to control a temperature value; a transition control unit configured to stochastically determine whether or not the state transition is to be accepted, based on the temperature value, a variation of the energy value of the first evaluation function, and a random number; a second evaluation function calculation unit configured to calculate an energy value of the second evaluation function after the state transition; and an energy comparing unit configured to output a minimum energy value of the energy value of the first evaluation function and values of the state variables when the minimum energy value is obtained by the first evaluation function, by comparing the energy value of the first evaluation function after the state transition with an energy value of the first evaluation function before the state transition, or to output a minimum energy value of the energy value of the second evaluation function and values of the state variables when the minimum energy value is obtained by the second evaluation function, by comparing the energy value of the second evaluation function after the state transition with an energy value of the second evaluation function before the state transition.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 illustrates an embodiment of an optimization apparatus and a method of controlling the optimization apparatus;

FIG. 2 illustrates an example of state transition in a travelling salesman problem;

FIG. 3 is a flowchart illustrating an example of an operation of the optimization apparatus illustrated in FIG. 1;

FIG. 4 illustrates another embodiment of the optimization apparatus and the method of controlling the optimization apparatus;

FIG. 5 is a flowchart illustrating an example of an operation of the optimization apparatus illustrated in FIG. 4;

FIG. 6 illustrates yet another embodiment of the optimization apparatus and the method of controlling the optimization apparatus; and

FIG. 7 is a flowchart illustrating an example of an operation of the optimization apparatus illustrated in FIG. 6.

### DESCRIPTION OF EMBODIMENT

Hereinafter, embodiments of the present disclosure will be described with reference to the drawings. In the following description, elements having substantially identical features are given the same reference symbols and overlapping descriptions may be omitted.

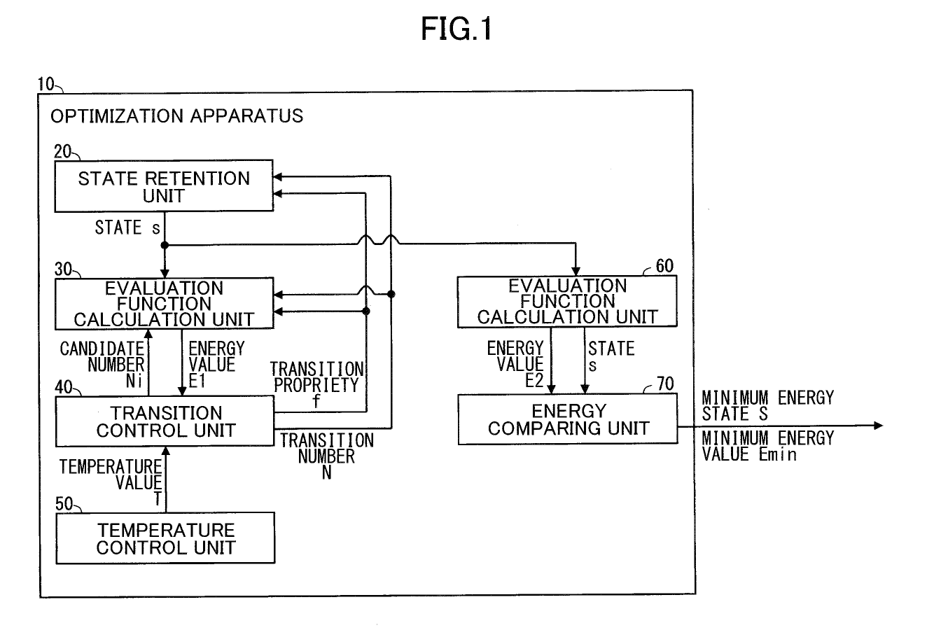

FIG. 1 illustrates an embodiment of an optimization apparatus and a method of controlling the optimization apparatus. The optimization apparatus 10 illustrated in FIG. 1 is, for example, an information processing apparatus solving a combinatorial optimization problem by executing the simulated annealing. For example, the optimization apparatus 10 searches for an optimal solution which minimizes an output value of an evaluation function (energy function) representing energy, by using the simulated annealing. In the following description, an evaluation result of an evaluation function (an output value of the evaluation function) may also be referred to as an energy value.

For example, a function called an Ising-like energy function is used as an evaluation function. The Ising-like energy function is used for an analysis of interaction between spins of a magnetic body. It is known that a combinatorial optimization problem can be mapped to the Ising-like energy function. In a case in which the combinatorial optimization problem is mapped to the Ising-like energy function, an evaluation function E(x) representing energy in accordance with a state of bits (the state is one of two discrete values of “0” and “1”) is expressed as the following formula (1):

$$E ( x ) = - {\sum }_{〈 i , j 〉} {W}_{ij} {x}_{i} {x}_{j} - {\sum }_{i} {b}_{i} {x}_{i} \qquad ( 1 )$$

A state variable x in the formula (1) represents a state (“0” or “1”) of a bit indicated by a suffix (such as i or j). For example, a value of a state variable xᵢ represents a value (“0” or “1”) of bit i, and a value of a state variable xⱼ represents a value (“0” or “1”) of bit j. Also, a coefficient Wᵢⱼ in the formula (1) represents a coupling coefficient of a bit i and a bit j, and “Wᵢⱼ=Wⱼᵢ”, and “Wᵢᵢ=0”. A coefficient bᵢ in the formula (1) represents a bias to a bit i. Note that the evaluation function E(x) used by the optimization apparatus 10 is not limited to the Ising-like energy function.

Further, for example, in a case in which a travelling salesman problem solving the shortest route for a salesperson visiting every city once and returning to an original location is mapped to the evaluation function as a combinatorial optimization problem, the evaluation function E(x) is defined as “distance+sum of penalty”. The evaluation function E(x) for the travelling salesman problem is represented by the following formula (2) by using a coefficient dᵢⱼ indicating a distance between a city i and a city j and a penalty coefficient P indicating a weight of a constraint.

$$E ( x ) = {\sum }_{i} {\sum }_{j} {\sum }_{k} {d}_{ij} {x}_{i * M + k} {x}_{j * M + k + 1} + P {\sum }_{k} {( {\sum }_{i} {x}_{i * M + k} - 1 )}^{2} + p {\sum }_{i} {( {\sum }_{k} {x}_{i * M + k} - 1 )}^{2} \qquad ( 2 )$$

A first term in the right side of the formula (2) represents a distance traveled by a salesperson. A second term in the right side of the formula (2) represents a penalty which is given when a constraint that a salesperson does not visit multiple cities at the same time is not satisfied. That is, the second term represents a value which is added when a salesperson visits multiple cities at the same time. A third term in the right side of the formula (2) represents a penalty which is given when a constraint that a salesperson does not visit the same city multiple times is not satisfied. That is, the third term represents a value which is added when a salesperson visits the same city multiple times.

M in the formula (2) represents the number of cities, and a suffix k represents an order of visiting a city. For example, a state variable xᵢ*_{M+k} is set to “1” when a city i is a k-th visit place, and xᵢ*_{M+k} is set to “0” when a city i is not a k-th visit place. Similarly, a state variable xⱼ*_{M+k+1} is set to “1” when city j is a (k+1)-th visit place, and xⱼ*_{M+k+1} is set to “0” when city j is not a (k+1)-th visit place. A state variable xⱼ*_{M+k+1} when k reaches the number of cities M represents a state variable xⱼ*_{M+1}.

A coefficient of a state variable x of a term of degree 2 when the formula (2) is expanded corresponds to the coefficient Wᵢⱼ in the formula (1), and a coefficient of a state variable x of a term of degree 1 corresponds to the coefficient bᵢ in the formula (1). That is, the coefficients Wᵢⱼ and bᵢ in the formula (1) contain a penalty coefficient. Note that a penalty coefficient P of the second term in the right side of the formula (2) may be equal to a penalty coefficient P of the third term in the right side of the formula (2). Alternatively, the penalty coefficient P of the second term in the right side of the formula (2) may be different from the penalty coefficient P of the third term in the right side of the formula (2).

Note that the evaluation function E(x) for the travelling salesman problem is not limited to the above formula (2). Also, a type of a combinatorial optimization problem to be solved by the optimization apparatus 10 is not limited to the travelling salesman problem. For example, a combinatorial optimization problem to be solved by the optimization apparatus 10 may be a knapsack problem for maximizing a sum of values of items to be put in a knapsack, a vehicle routing problem for minimizing a sum of time for delivery, or a scheduling problem for minimizing a total time of work. In the knapsack problem, an upper limit of a total weight of items to be put in a knapsack and the like are used as constraints. In the vehicle routing problem, an upper limit of the number of trucks and the like are used as constraints. In the scheduling problem, upper limits of the number of workers and the number of machines and the like are used as constraints. In the following, an operation of the optimization apparatus 10 will be described by referring to a case in which the travelling salesman problem is solved using the formula (2).

The optimization apparatus 10 searches for a solution of a combinatorial optimization problem using an evaluation function E1(x) indicated in a formula (3) below, and determines a solution of the combinatorial optimization problem using an evaluation function E2(x) indicated in a formula (4).

$$\begin{matrix}E 1 ( x ) = {\sum }_{i} {\sum }_{j} {\sum }_{k} {d}_{ij} {x}_{i * M + k} {x}_{j * M + k + 1} + P 1 {\sum }_{k} {( {\sum }_{i} {x}_{i * M + k} - 1 )}^{2} + P 1 {\sum }_{i} {( {\sum }_{k} {x}_{i * M + k} - 1 )}^{2} & ( 3 ) \\ E 2 ( x ) = {\sum }_{i} {\sum }_{j} {\sum }_{k} {d}_{ij} {x}_{i * M + k} {x}_{j * M + k + 1} + P 2 {\sum }_{k} {( {\sum }_{i} {x}_{i * M + k} - 1 )}^{2} + P 2 {\sum }_{i} {( {\sum }_{k} {x}_{i * M + k} - 1 )}^{2} & ( 4 )\end{matrix}$$

The evaluation function E1(x) in the formula (₃) is made by replacing the penalty coefficient P in the formula (2) with a penalty coefficient P1. The evaluation function E2(x) in the formula (4) is made by replacing the penalty coefficient P in the formula (2) with a penalty coefficient P2 which is larger than the penalty coefficient P1. The evaluation function E2(x) in the formula (4) is the same as (or similar to) the evaluation function E1(x) except for the penalty coefficient P2. Thus, when the evaluation functions E1(x) and E2(x) are to be correlated with the above formula (1), coefficients corresponding to Wᵢⱼ and bᵢ in the formula (1) differ between the evaluation functions E1(x) and E2(x). Regarding the penalty coefficient P1 in the formula (3), the penalty coefficient P1 of the second term and the penalty coefficient P1 of the third term may be the same, or may be different. Similarly, regarding the penalty coefficient P2 in the formula (4), the penalty coefficient P2 of the second term and the penalty coefficient P2 of the third term may be the same, or may be different. The evaluation function E1(x) indicated in the formula (3) is an example of a first evaluation function, and the penalty coefficient P1 is an example of a first penalty coefficient. The evaluation function E2(x) indicated in the formula (4) is an example of a second evaluation function, and the penalty coefficient P2 is an example of a second penalty coefficient. In the following description, when the evaluation functions E1(x) and E2(x) are not distinguished with each other, each of them may be referred to as “evaluation function E(x)”.

As illustrated in FIG. 1, the optimization apparatus 10 includes a state retention unit 20, an evaluation function calculation unit 30, a transition control unit 40, a temperature control unit 50, an evaluation function calculation unit 60, and an energy comparing unit 70. The evaluation function calculation unit 30 is an example of a first evaluation function calculation unit, and the evaluation function calculation unit 60 is an example of a second evaluation function calculation unit.

The state retention unit 20 retains values of state variables xᵢ (i is a spin number) included in the evaluation function E(x) representing energy. A set of the values of the state variables xᵢ retained by the state retention unit 20 represents a current state s. The state retention unit 20 outputs information representing the retained state s (a set of the state variables xᵢ) to the evaluation function calculation unit 30 and the evaluation function calculation unit 60.

The evaluation function calculation unit 30 calculates, for example, an energy value E1 at a current state s based on the state s received from the state retention unit 20 and on the evaluation function E1(x). Also, the evaluation function calculation unit 30 receives a candidate number Ni which represents a candidate of state transition, in which a change of one of the state variables xᵢ occurs, from the current state s to a next state s, and calculates an energy value E1 of the evaluation function E1(x) when the state transition occurs, based on the candidate number Ni. As an energy value E1 can be calculated by using a well-known method, detailed description of the calculation is omitted.

The transition control unit 40 receives, from the temperature control unit 50, a temperature value T representing a temperature which is a parameter used in the simulated annealing, and receives, from the evaluation function calculation unit 30, the energy value E1 when the state transition designated by the candidate number Ni occurs. Also, the transition control unit 40 includes a random number generator (not illustrated in the drawings) generating a random number. Note that the random number generator may be provided outside the transition control unit 40.

For example, the transition control unit 40 calculates a variation of an energy value E1, based on the energy value E1 received from the evaluation function calculation unit 30. The variation of an energy value E1 is a difference between an energy value E1 at a state in which one of the state variables xᵢ is changed from a current state s (which is an energy value E1 transmitted from the evaluation function calculation unit 30 to the transition control unit 40) and an energy value E1 at the current state s. Note that the variation of an energy value E1 may be calculated in the evaluation function calculation unit 30.

Subsequently, by using the temperature value T, the variation of the energy value E1 of the evaluation function E1(x), and a random number, the transition control unit 40 stochastically determines whether the state transition is to be accepted or not, in accordance with a relative relationship between the variation and thermal excitation energy. As a method of stochastically determining whether or not to accept state transition by using the temperature value T, the variation of the energy value E1 of the evaluation function E1(x), and a random number is well-known, detailed description of the method is omitted.

The transition control unit 40 outputs a transition propriety f and a transition number N to the evaluation function calculation unit 30. The transition propriety f indicates a determination result as to whether state transition is to be accepted or not, and a transition number N indicates a state variable x of which a state (value) is to be changed.

If the transition propriety f indicates that state transition is to be accepted, the state retention unit 20 updates the current state s into a next state s, by changing a value of the state variable x indicated by the transition number N, and retains the updated state s as the current state s. The state retention unit 20 also outputs the updated state s (current state s) to the evaluation function calculation unit 30 and the evaluation function calculation unit 60. By the above described operation being performed, state transition occurs repeatedly. By repeating state transition, an optimal solution, or an approximate solution having an energy value close to an energy value of an optimal solution can be obtained.

If the transition propriety f indicates that state transition is not accepted, the state retention unit 20 does not update the current state s and maintains the current state s. In this case, the evaluation function calculation unit 30 calculates an energy value E1 of the evaluation function E1(x) when a value of a state variable xᵢ which is different from the previous state transition is changed, and outputs the calculated energy value E1 to the transition control unit 40. The transition control unit 40 then stochastically determines whether or not to accept the state transition which is different from the previous one. As described above, until it is determined that state transition is to be accepted, a search of a state variable xᵢ of which a value is to be changed is continued.

The temperature control unit 50 controls the temperature value T which is output to the transition control unit 40. For example, in accordance with the number of repetitions of the above mentioned process for stochastically determining whether or not to accept the state transition, the transition control unit 40 decreases the temperature value T logarithmically from an initial temperature value.

The evaluation function calculation unit 60 calculates an energy value E2 of the evaluation function E2(x) having the penalty coefficient P2 larger than the penalty coefficient P1. For example, every time a current state s is received from the state retention unit 20, the evaluation function calculation unit 60 calculates the energy value E2 at the current state s based on the evaluation function E2(x). Thus, the energy value E2 of the evaluation function E2(x) at a transited state is calculated. That is, when a state transition in which one of the state variables xᵢ is changed occurs, the evaluation function calculation unit 60 calculates the energy value E2 of the evaluation function E2(x) at the transited state. Note that, in the present disclosure, when a certain state transition occurs (suppose the state transition is denoted as “Ta”), a calculated energy value when (after) the state transition Ta occurs may be referred to as an “energy value with respect to the state transition Ta” or an “energy value after the state transition Ta”. The evaluation function calculation unit 60 then outputs the energy value E2 to the energy comparing unit 70. Further, the evaluation function calculation unit 60 outputs a set of values of the state variables xᵢ used for the calculation of the energy value E2 (that is, the state s received from the state retention unit 20) to the energy comparing unit 70. Note that a method of calculating the energy value E2 is the same as (or similar to) the method performed by the evaluation function calculation unit 30.

The energy comparing unit 70 compares the energy value E2 calculated by the evaluation function calculation unit 60 with the previously received value (energy value E2), to output the smallest energy value (denoted by Emin) among the previously received energy values E2 and a state S when the smallest energy value Emin is obtained. In the following, the smallest energy value Emin may also be referred to as a minimum energy value Emin.

For example, as the minimum energy value Emin, the energy comparing unit 70 retains the smallest value among the energy values E2 which have been calculated by the evaluation function calculation unit 60 in the past, and the energy comparing unit 70 also retains, as a minimum energy state S, a set of the state variables xᵢ when the minimum energy value Emin is obtained. That is, at the last state, the energy comparing unit 70 retains, as the minimum energy value Emin, the smallest energy value E2 among the energy values E2 which have been calculated by the evaluation function calculation unit 60 in the past, and also retains the minimum energy state S. When a new state transition occurs (that is, when a state has transited to the current state s), the energy comparing unit 70 compares, with the retained minimum energy value Emin, the energy value E2 at the current state s calculated by the evaluation function calculation unit 60, and determines, based on a result of the comparison, whether or not the retained minimum energy value Emin is to be updated. For example, if the energy value E2 at the current state s calculated by the evaluation function calculation unit 60 is smaller than the retained minimum energy value Emin, the energy comparing unit 70 updates the minimum energy value Emin into the energy value E2 at the current state s. The energy comparing unit 70 also updates the minimum energy state S into a set of the state variables xᵢ which is used when the new minimum energy value Emin is calculated. When optimization of the values of the state variables xᵢ is terminated, the energy comparing unit 70 outputs the retained minimum energy value Emin and the minimum energy state S (the set of the state variables xᵢ when the retained minimum energy value Emin is obtained). Accordingly, the energy comparing unit 70 can output the smallest energy value Emin among multiple energy values E2 obtained by repeating state transition, and can output, as the minimum energy state S, a state s when the smallest energy value Emin can be obtained.

As described above, the optimization apparatus 10 uses the evaluation function E1(x) having the penalty coefficient P1 smaller than the penalty coefficient P2 when searching for solutions of a combinatorial optimization problem. In a state in which a constraint is not satisfied, the energy value E1 of the evaluation function E1(x) becomes smaller than an energy value E of an evaluation function E(x) having a penalty coefficient P larger than P1. Thus, in the optimization apparatus 10, as compared to a case in which the evaluation function E(x) having the penalty coefficient P larger than P1 is used, a probability of transiting from a local solution to a solution not satisfying a constraints increases. As a result, because a time required for escaping from a local solution can be shortened, optimization can be processed quickly.

The optimization apparatus 10 also uses the evaluation function E2(x) having the penalty coefficient P2 larger than the penalty coefficient P1 when determining the minimum energy state S. Thus, the optimization apparatus 10 can reduce a case in which a state not satisfying a constraint is output as the minimum energy state S, as compared to a case in which an evaluation function E(x) having a penalty coefficient P smaller than P2 is used.

That is, by using different evaluation functions E1(x) and E2(x) for searching for solutions of a combinatorial optimization problem and for determining the minimum energy state S, the optimization apparatus 10 can perform an optimization processing quickly while avoiding outputting a solution not satisfying a constraint. In other words, the optimization apparatus 10 encourages state transition by accepting transition to a solution not satisfying a constraint but having energy close to an optimal solution, and suppresses outputting the solution not satisfying a constraint as an optimal solution.

The optimization apparatus 10 and a method of controlling the optimization apparatus 10 are not limited to the example illustrated in FIG. 1. For example, the energy comparing unit 70 may receive the energy value E1 calculated by the evaluation function calculation unit 30 and the current state s (a set of values of the state variables xᵢ) from the evaluation function calculation unit 30. In addition, if the energy value E1 at the current state s becomes equal to the energy value E2 at the current state s, the energy comparing unit 70 may determine that the current state s satisfies a constraint, and may compare the energy value E1 at the current state s with energy values E1 in past states satisfying a constraint which were obtained so far. In this case, the energy comparing unit 70 may output the smallest energy value as Emin, among the energy values E1 in the states satisfying a constraint, and may also output, as the minimum energy state S, a set of values of the state variables xᵢ which are used for calculating the smallest energy value (Emin). That is, the energy comparing unit 70 may compare either the energy value E1 or the energy value E2 with energy values having been obtained by using the same evaluation function so far, and may select the smallest energy value as Emin.

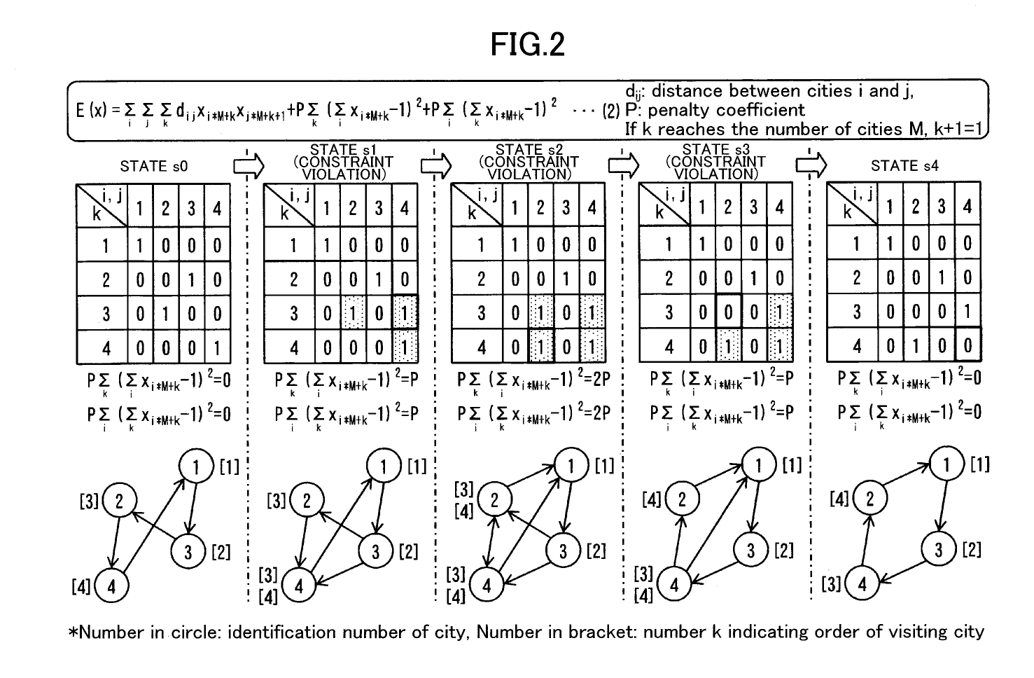

FIG. 2 illustrates an example of state transition in the travelling salesman problem. In FIG. 2, the same evaluation function E(x) as the above described formula (2) is illustrated, and the evaluation function E1(x) and the evaluation function E2(x) are not distinguished. A number in each circle represents an identification number of a city, and a number in each bracket represents an order k in which the city (identified by the number in the circle) is visited. Note that in the following paragraphs explaining the state transition in FIG. 2, a state variable x_{p,q} is used for representing a variable indicating whether or not city p (a city of an identification number p) is a q-th visit place. When x_{p,q} is “1”, the city p is a q-th visit place, and when x_{p,q} is “0”, the city p is not a q-th visit place. FIG. 2 illustrates a case in which the number of cities to be visited is four. Thus, when the order k is 4, (k+1) represents 1. That is, a state variable x_{j,k+1} represents x_{j,1}.

In a case in which the Ising-like energy function is used as the evaluation function E(x), the optimization apparatus 10 searches for an optimal solution in which the energy value E becomes minimum, by changing the state variables in the evaluation function E(x) one by one. Thus, during an optimization processing, a state not satisfying a constraint (constraint violation state) may occur. In the example illustrated in FIG. 2, while a state is changed from a state s0 satisfying a constraint to another state s4 satisfying a constraint, state transition through s1, s2, and s3 of the constraint violation state occurs.

The first state s0 represents a case in which a salesperson visits the cities in an order of a city 1, a city 3, a city 2, and a city 4, and returns to the city 1. The case satisfies a constraint in which multiple cities are not visited at the same time and a constraint in which the same city is not visited multiple times.

Next, the current state s is changed from the state s0 to the state s1, by a value of a state variable x_{4,3} (a value in a table of the state s1 surrounded by a thick line) being changed from “0” to “1”. In the state s1, neither the constraint in which multiple cities are not visited at the same time, nor the constraint in which the same city is not visited multiple times is satisfied. For example, the state s1 includes constraint violation in which both the cities 2 and 4 are visited third (at the same time), and in which the city 4 is visited twice (shaded portions in the table of the state s1 represent the constraint violation). In this case, respective penalties represented by the second and third terms in the right side of the formula (2) are equal to the penalty coefficient P, and a sum of the penalty becomes a double of the penalty coefficient P.

Next, the current state s is changed from the state s1 to the state s2, by a value of a state variable x_{2,4} (a value in a table of the state s2 surrounded by a thick line) being changed from “0” to “1”. In the state s2, neither the constraint in which multiple cities are not visited at the same time, nor the constraint in which the same city is not visited multiple times is satisfied. For example, the state s2 includes, in addition to the constraint violation in the state s1, constraint violation in which both the cities 2 and 4 are visited fourth (at the same time), and in which the city 2 is visited twice (shaded portions in the table of the state s2 represent the constraint violation). In this case, respective penalties represented by the second and third terms in the right side of the formula (2) are equal to twice the penalty coefficient P, and a sum of the penalty becomes a quadruple of the penalty coefficient P.

Next, the current state s is changed from the state s2 to the state s3, by a value of a state variable x_{2,3} (a value in a table of the state s3 surrounded by a thick line) being changed from “1” to “0”. In the state s3, neither the constraint in which multiple cities are not visited at the same time, nor the constraint in which the same city is not visited multiple times is satisfied. For example, the state s3 includes constraint violation in which both the cities 2 and 4 are visited fourth (at the same time), and in which the city 4 is visited twice (shaded portions in the table of the state s3 represent the constraint violation). In this case, respective penalties represented by the second and third terms in the right side of the formula (2) are equal to the penalty coefficient P, and a sum of the penalty becomes a double of the penalty coefficient P.

Next, the current state s is changed from the state s3 to the state s4, by a value of a state variable x_{4,4} (a value in a table of the state s4 surrounded by a thick line) being changed from “1” to “0”. The state s4 represents a case in which a salesperson visits the cities in an order of the city 1, the city 3, the city 4, and the city 2, and returns to the city 1. The case satisfies the constraint in which multiple cities are not visited at the same time and the constraint in which the same city is not visited multiple times.

A probability of transiting from a local solution such as the state s0 to a solution not satisfying the constraint condition such as the state s1 becomes larger as the penalty coefficient P included in the evaluation function E(x) becomes smaller. Thus, the optimization apparatus 10 causes state transition, necessary for searching for the optimal solution of the combinatorial optimization problem, to occur by using the evaluation function E1(x) having the penalty coefficient P1 smaller than the penalty coefficient P2. Accordingly, in the optimization apparatus 10, a time required for escaping from a local solution can be shortened as compared to a case in which the evaluation function E(x) having the penalty coefficient P larger than P1 is used.

If the penalty coefficient is too small, a solution not satisfying a constraint may be output as the optimal solution. Suppose a case in which a salesperson does not move from the city 1 of a start point. In this case, the first term in the right side of the formula (2) (a distance traveled) and the second term in the right side of the formula (2) (a penalty for the violation in which multiple cities are visited at the same time) become “0”, and the third term in the right side of the formula (2) (a penalty for the violation in which the same city is visited multiple times) becomes twelve times the penalty coefficient P (=(4−1)²+(0−1)²+(0−1)²+(0−1)²). That is, if the salesperson does not move from the city 1 of the start point, the energy value E becomes twelve times the penalty coefficient P. Further, if a distance between adjacent cities is “9”, the energy value E at the state s4 becomes “36”. It means that, if the penalty coefficient P is less than “3”, the energy value E of the solution not satisfying the constraint (a case of not moving from the start point (city 1)) becomes less than the energy value E of the optimal solution, and that the solution not satisfying the constraint is output as the optimal solution.

Therefore, as described above with reference to FIG. 1, because the optimization apparatus 10 determines the minimum energy state S using the evaluation function E2(x) having the penalty coefficient P2 larger than the penalty coefficient P1, to exclude a solution not satisfying a constraint, a case in which a solution not satisfying a constraint is output as the optimal solution can be avoided. As the optimization apparatus 10 can exclude a solution not satisfying a constraint by using the evaluation function E2(x), the optimization apparatus 10 can set a magnitude of the penalty coefficient P1 in the evaluation function E1(x) used for searching for solutions of a combinatorial optimization problem smaller, as compared to a case in which the evaluation function E2(x) is not used. As a result, the optimization apparatus 10 can perform the optimization processing quickly.

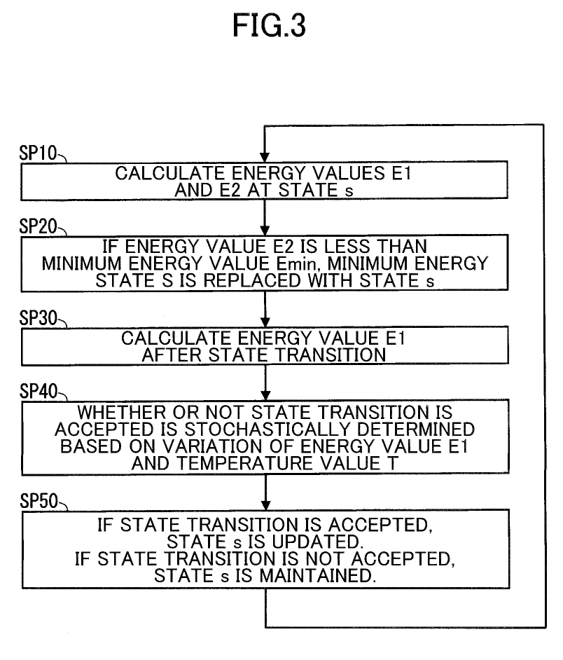

FIG. 3 is a flowchart illustrating an example of an operation of the optimization apparatus 10 illustrated in FIG. 1. The operation illustrated in FIG. 3 is an example of the method of controlling the optimization apparatus 10. For example, after initial values of the state variables x included in the evaluation functions E1(x) and E2(x) are given, the optimization apparatus 10 repeats execution of a series of steps from step SP10 to step SP50 for a predetermined number of times. After the series of steps from step SP10 to step SP50 are executed for the predetermined number of times, the optimization apparatus 10 outputs the minimum energy value Emin (the smallest energy value E2) and the minimum energy state S which are retained by the energy comparing unit 70.

At step SP10, the evaluation function calculation unit 30 calculates the energy value E1 of the evaluation function E1(x) at the current state s received from the state retention unit 20, and the evaluation function calculation unit 60 calculates the energy value E2 of the evaluation function E2(x) at the current state s received from the state retention unit 20.

Next, at step SP20, if the energy value E2 calculated at step SP10 is less than the minimum energy value Emin, the evaluation function calculation unit 60 replaces the minimum energy state S with the state s (the current state, which is a state used for calculating the energy value E2 at a previous step (SP10)). The evaluation function calculation unit 60 also replaces the minimum energy value Emin with the energy value E2 calculated at step SP10, if the energy value E2 calculated at step SP10 is less than the minimum energy value Emin. As described above with reference to FIG. 1, a minimum energy value Emin before update is the smallest energy value E2 among the energy values E2 having been calculated before the energy value E2 at the current state s is calculated.

Next, at step SP30, the evaluation function calculation unit 30 calculates the energy value E1 when state transition occurs, in which one of the state variables xᵢ is changed from the current state s.

Next, at step SP40, based on a variation of the energy value E1 (a difference between the energy value E1 calculated at step SP10 and the energy value E1 calculated at step SP30) and the temperature value T, the transition control unit 40 stochastically determines whether the state transition is to be accepted or not.

Next, at step SP50, if it is determined at step SP40 that the state transition is to be accepted, the state retention unit 20 updates the current state s into a new state s which is used for calculating the energy value E1 with respect to the state transition (values of the state variables xᵢ used at step SP30). If it is determined at step SP40 that the state transition is not accepted, the state retention unit 20 maintains the current state s, without performing the update. The state retention unit 20 also outputs the current state s to the evaluation function calculation unit 30 and the evaluation function calculation unit 60. After step SP50 is executed, the operation reverts to step SP10, and the optimization apparatus 10 repeats the execution of the series of steps from step SP10 to step SP50.

The operation of the optimization apparatus 10 is not limited to the example illustrated in FIG. 3. For example, if the state s was not updated at step SP50 and the current state s is maintained, execution of step SP10 and step SP20 at a next loop may be omitted. Further, if the state s was updated at step SP50, when step SP10 is to be executed at a next loop, calculation of the energy value E1 at the (current) state s may be omitted. Instead, the energy value E1 calculated at step SP30 at a previous loop may be used as the energy value E1 at the (current) state s.

As described above, in the embodiment described above with reference to FIGS. 1 to 3, the optimization apparatus 10 uses the evaluation function E1(x) having the penalty coefficient P1 in order to search for solutions of a combinatorial optimization problem, and uses the evaluation function E2(x) having the penalty coefficient P2 different from P1 in order to determine a minimum energy state S. Because the penalty coefficient P2 included in the evaluation function E2(x) used for determining the minimum energy state S is larger than the penalty coefficient P1 included in the evaluation function E1(x) used for searching for solutions of the combinatorial optimization problem, the optimization apparatus 10 encourages state transition by accepting transition to a solution which has energy close to an optimal solution but which does not satisfy a constraint, and can suppress outputting the solution not satisfying a constraint as an optimal solution.

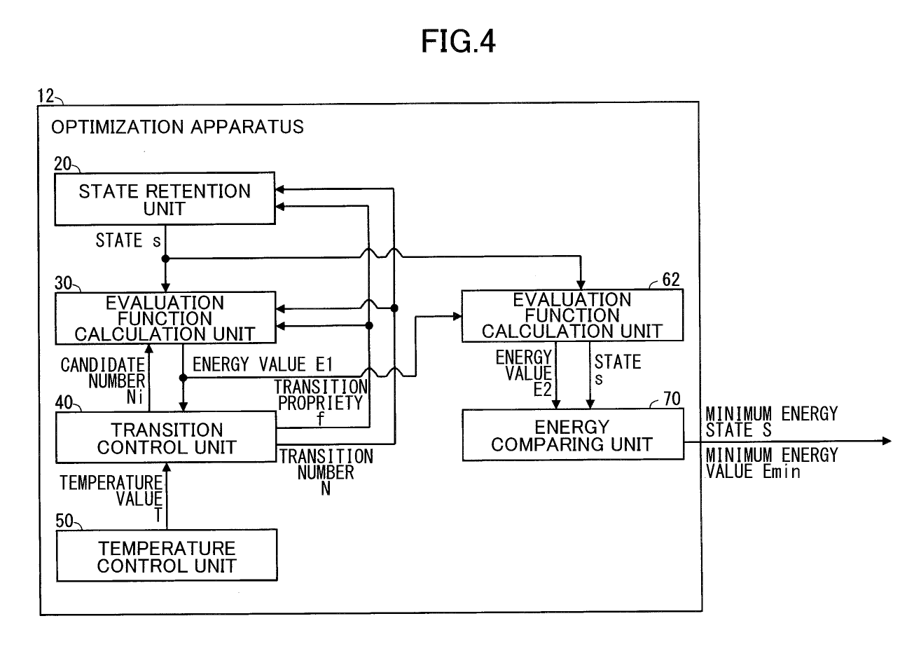

FIG. 4 illustrates another embodiment of the optimization apparatus and the method of controlling the optimization apparatus. With respect to an element which is the same as (or similar to) the element described above with reference to FIGS. 1 to 3, the same or similar reference symbol is attached, and detailed description about the element is omitted. The optimization apparatus 12 illustrated in FIG. 4 is the same as (or similar to) the optimization apparatus 10 illustrated in FIG. 1, except that the optimization apparatus 12 includes an evaluation function calculation unit 62 instead of the evaluation function calculation unit 60. For example, the optimization apparatus 12 includes the state retention unit 20, the evaluation function calculation unit 30, the transition control unit 40, the temperature control unit 50, the evaluation function calculation unit 62, and the energy comparing unit 70. The evaluation function calculation unit 62 is an example of a second evaluation function calculation unit. In FIG. 4, because the state retention unit 20, the evaluation function calculation unit 30, the transition control unit 40, the temperature control unit 50, and the energy comparing unit 70 are the same as (or similar to) those described above with reference to FIGS. 1 to 3, the evaluation function calculation unit 62 is mainly explained.

Similar to the evaluation function calculation unit 60 illustrated in FIG. 1, the evaluation function calculation unit 62 calculates an energy value E2 of the evaluation function E2(x) having the penalty coefficient P2 larger than the penalty coefficient P1. For example, the evaluation function calculation unit 62 is configured to receive a current state s from the state retention unit 20, and the evaluation function calculation unit 62 calculates the energy value E2 at the current state s based on the evaluation function E2(x), every time the current state s is received from the state retention unit 20. The evaluation function calculation unit 62 further receives, from the evaluation function calculation unit 30, an energy value E1 at the current state s calculated by the evaluation function calculation unit 30.

That the energy values E1 and E2 at the current state s are identical indicates that the current state s satisfies a constraint. Thus, if the calculated energy value E2 at the current state s is equal to the energy value E1 at the current state s calculated by the evaluation function calculation unit 30, the evaluation function calculation unit 62 outputs the calculated energy value E2 at the current state s to the energy comparing unit 70. In this case, the evaluation function calculation unit 62 also outputs, to the energy comparing unit 70, the (current) state s received from the state retention unit 20, which is a set of values of the state variables xᵢ used for calculating the energy value E2 to be output to the energy comparing unit 70.

Note that the evaluation function calculation unit 62 does not output the calculated energy value E2 at the current state s or the like to the energy comparing unit 70, if the calculated energy value E2 at the current state s is not equal to the energy value E1 at the current state s calculated by the evaluation function calculation unit 30.

Accordingly, in the optimization apparatus 12, if the energy values E1 and E2 with respect to a new state transition (at the current state s) calculated by the evaluation function calculation units 30 and 62 respectively are identical, the energy comparing unit 70 determines whether the minimum energy value Emin retained by the energy comparing unit 70 is to be updated or not. In other words, if the energy values E1 and E2 with respect to a new state transition (at the current state s) calculated by the evaluation function calculation units 30 and 62 respectively are not identical, the energy comparing unit 70 does not update the minimum energy value Emin retained by the energy comparing unit 70.

As described above, in a case in which the current state s satisfies a constraint, the optimization apparatus 12 determines whether the retained minimum energy value Emin is to be updated or not, by comparing the calculated energy value E2 at the current state s with the retained minimum energy value Emin. That is, a solution not satisfying a constraint is excluded from an object for the comparison. Therefore, the optimization apparatus 12 can further suppress outputting the solution not satisfying a constraint as an optimal solution.

The optimization apparatus 12 and the method of controlling the optimization apparatus 12 are not limited to the example illustrated in FIG. 4. For example, a determination whether or not the calculated energy values E1 and E2 at the current state s are identical may be performed by the energy comparing unit 70. Further, for example, the penalty coefficient P2 included in the evaluation function E2(x) may be smaller than the penalty coefficient P1 included in the evaluation function E1(x). That is, the penalty coefficient P2 is only required to be different from the penalty coefficient P1.

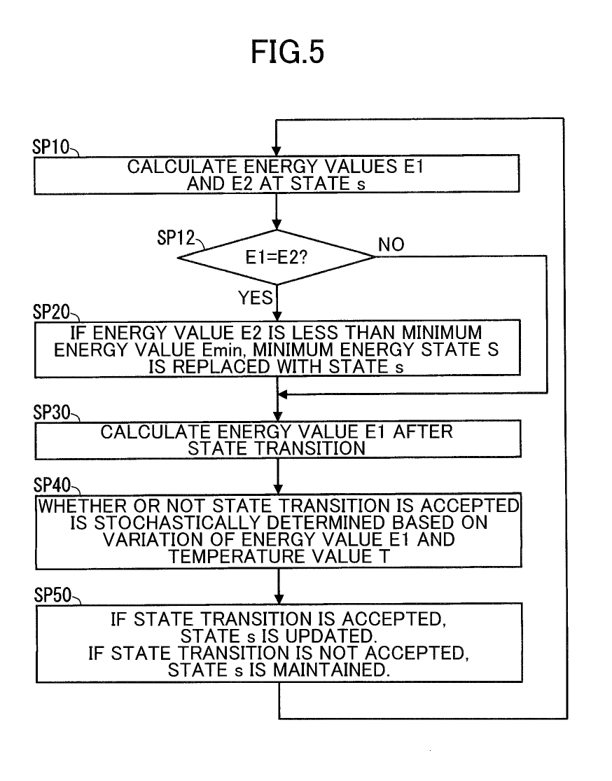

FIG. 5 is a flowchart illustrating an example of an operation of the optimization apparatus 12 illustrated in FIG. 4. The operation illustrated in FIG. 5 is an example of the method of controlling the optimization apparatus 12. For example, after initial values of the state variables x included in the evaluation functions E1(x) and E2(x) are given, the optimization apparatus 12 repeats execution of a series of steps from step SP10 to step SP50 for a predetermined number of times. After the series of steps from step SP10 to step SP50 are executed for the predetermined number of times, the optimization apparatus 12 outputs the minimum energy value Emin (the smallest energy value E2) and the minimum energy state S which are retained by the energy comparing unit 70.

The operation illustrated in FIG. 5 is the same as or similar to the operation illustrated in FIG. 3, except that step SP12 is added to the operation illustrated in FIG. 3. With respect to steps in FIG. 5 which are the same as (or similar to) the steps in FIG. 3, the same or similar reference symbol are attached, and detailed description of these steps is omitted.

At step SP10, the evaluation function calculation unit 30 calculates the energy value E1 of the evaluation function E1(x) at the current state s received from the state retention unit 20, and the evaluation function calculation unit 62 calculates the energy value E2 of the evaluation function E2(x) at the current state s received from the state retention unit 20.

Next, at step SP12, the evaluation function calculation unit 62 determines if the energy value E2 calculated at step SP10 is equal to the energy value E1 calculated at step SP10 by the evaluation function calculation unit 30. If the energy values E1 and E2 are identical, the operation of the optimization apparatus 12 proceeds to step SP20. If the energy values E1 and E2 are not identical, the operation of the optimization apparatus 12 proceeds to step SP30. That is, if the energy values E1 and E2 are different from each other, a process at step SP20 for replacing the minimum energy state S with the current state s is not performed.

At step SP20, if the energy value E2 calculated at step SP10 is less than the minimum energy value Emin, the evaluation function calculation unit 62 replaces the minimum energy state S with the state s. The evaluation function calculation unit 62 also replaces the minimum energy value Emin with the energy value E2 calculated at step SP10. After step SP20, the operation of the optimization apparatus 12 proceeds to step SP30.

At step SP30, the evaluation function calculation unit 30 calculates the energy value E1 when state transition occurs, in which one of the state variables xᵢ is changed from the current state s.

Next, at step SP40, based on a variation of the energy value E1 (a difference between the energy value E1 calculated at step SP10 and the energy value E1 calculated at step SP30) and the temperature value T, the transition control unit 40 stochastically determines whether the state transition is to be accepted or not.

Next, at step SP50, if it is determined at step SP40 that the state transition is to be accepted, the state retention unit 20 updates the current state s into a new state s which is used for calculating the energy value E1 with respect to the state transition (values of the state variables xᵢ used at step SP30). If it is determined at step SP40 that the state transition is not accepted, the state retention unit 20 maintains the current state s, without performing the update. The state retention unit 20 also outputs the current state s to the evaluation function calculation unit 30 and the evaluation function calculation unit 62. After step SP50 is executed, the operation reverts to step SP10, and the optimization apparatus 12 repeats the execution of the series of steps from step SP10 to step SP50.

The operation of the optimization apparatus 12 is not limited to the example illustrated in FIG. 5. For example, the determination at step SP12 may be performed by the energy comparing unit 70. Further, for example, if the state s was not updated at step SP50 and the current state s is maintained, execution of step SP10 and step SP20 at a next loop may be omitted. Further, if the state s was updated at step SP50, when step SP10 is to be executed at a next loop, calculation of the energy value E1 at the (current) state s may be omitted. Instead, the energy value E1 calculated at step SP30 at a previous loop may be used as the energy value E1 at the (current) state s.

As described above, in the present embodiment described with reference to FIGS. 4 to 5, a similar effect to the embodiment described with reference to FIGS. 1 to 3 can be obtained. That is, the optimization apparatus 12 encourages state transition by accepting transition to a solution which has energy close to an optimal solution but which does not satisfy a constraint, and can suppress outputting the solution not satisfying a constraint as an optimal solution. For example, the optimization apparatus 12 uses the evaluation function E1(x) having the penalty coefficient P1 in order to search for solutions of a combinatorial optimization problem, and uses the evaluation function E2(x) having the penalty coefficient P2 different from P1 in order to determine a minimum energy state S. If the energy value E1 at the current state s which is calculated based on the evaluation function E1(x) is equal to the energy value E2 at the current state s which is calculated based on the evaluation function E2(x), the optimization apparatus 12 determines whether the minimum energy value Emin is to be updated or not. Note that the energy value E1 at the current state s which is calculated based on the evaluation function E1(x) becomes equal to the energy value E2 at the current state s which is calculated based on the evaluation function E2(x), in a case in which the current state s satisfies a constraint. That is, if the current state s satisfies the constraint, the optimization apparatus 12 determines whether the minimum energy value Emin is to be updated or not, by comparing the energy value E2 at the current state s which is calculated based on the evaluation function E2(x) with the minimum energy value Emin before transiting to the current state s. Accordingly, because a solution not satisfying the constraint is excluded from an object for the comparison, the optimization apparatus 12 can further suppress outputting the solution not satisfying the constraint as an optimal solution.

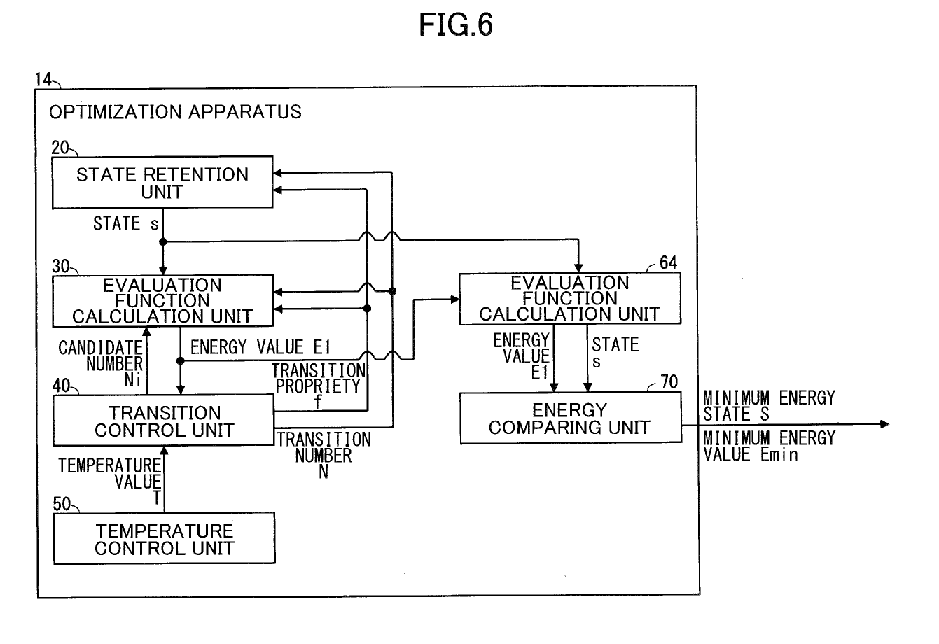

FIG. 6 illustrates yet another embodiment of the optimization apparatus and the method of controlling the optimization apparatus. With respect to an element which is the same as (or similar to) the element described above with reference to FIGS. 1 to 5, the same or similar reference symbol is attached, and detailed description about the element is omitted. The optimization apparatus 14 illustrated in FIG. 6 is the same as (or similar to) the optimization apparatus 12 illustrated in FIG. 4, except that the optimization apparatus 14 includes an evaluation function calculation unit 64 instead of the evaluation function calculation unit 62. For example, the optimization apparatus 14 includes the state retention unit 20, the evaluation function calculation unit 30, the transition control unit 40, the temperature control unit 50, the evaluation function calculation unit 64, and the energy comparing unit 70. The evaluation function calculation unit 64 is an example of a second evaluation function calculation unit. In FIG. 6, because the state retention unit 20, the evaluation function calculation unit 30, the transition control unit 40, the temperature control unit 50, and the energy comparing unit 70 are the same as (or similar to) those described above with reference to FIGS. 4 to 5, the evaluation function calculation unit 64 is mainly explained.

The evaluation function calculation unit 64 calculates the energy value E2 of an evaluation function E2(x) indicated in a formula (5). A definition of a state variable xᵢ is the same as that in the formula (2) described with reference to FIG. 1.

$$E 2 ( x ) = P 2 {\sum }_{k} {( {\sum }_{i} {x}_{i * M + k} - 1 )}^{2} + P 2 {\sum }_{i} {( {\sum }_{k} {x}_{i * M + k} - 1 )}^{2} \qquad ( 5 )$$

The evaluation function E2(x) in the formula (5) is composed of only terms having a penalty coefficient P2. When a state s (a set of values of the state variables xᵢ) satisfies a constraint, a value of the evaluation function E2(x) becomes “0”, and when the state s does not satisfy the constraint, the value of the evaluation function E2(x) becomes a non-zero value. Thus, the evaluation function E2(x) in the formula (5) represents whether or not the state s satisfies the constraint, or represents presence or absence of penalty. Note that the penalty coefficient P2 may be equal to the penalty coefficient P1 or may be different from the penalty coefficient P1. The evaluation function E2(x) in the formula (5) is an example of a function representing presence or absence of penalty.

For example, the evaluation function calculation unit 64 is configured to receive a current state s from the state retention unit 20, and the evaluation function calculation unit 64 calculates the energy value E2 (a value of the evaluation function E2(x) in the formula (5)) at the current state s based on the evaluation function E2(x), every time the current state s is received from the state retention unit 20. The evaluation function calculation unit 64 further receives, from the evaluation function calculation unit 30, an energy value E1 at the current state s calculated by the evaluation function calculation unit 30.

If the calculated energy value E2 with respect to a new state transition (at the current state s) indicates that penalty is not generated (when E2=0), the evaluation function calculation unit 64 outputs, to the energy comparing unit 70, the energy value E1 with respect to the new state transition which is calculated by the evaluation function calculation unit 30. In this case, the evaluation function calculation unit 64 also outputs, to the energy comparing unit 70, the (current) state s received from the state retention unit 20, which is a set of values of the state variables xᵢ used for calculating the energy value E1 to be output to the energy comparing unit 70.

Note that the evaluation function calculation unit 64 does not output, to the energy comparing unit 70, the calculated energy value E1 at the current state s which is calculated by the evaluation function calculation unit 30, or the like, if the calculated energy value E2 with respect to the new state transition indicates that penalty is generated (when E2 is not 0).

As described above, the evaluation function calculation unit 64 outputs the energy value E1 to the energy comparing unit 70, instead of the energy value E2. The energy comparing unit 70 in FIG. 6 is the same as (or similar to) the energy comparing unit 70 in FIG. 4, except that the energy comparing unit 70 in FIG. 6 receives the energy value E1 instead of the energy value E2. For example, the energy comparing unit 70 in the optimization apparatus 14 retains, as the minimum energy value Emin, the smallest energy value E1 among the energy values E1 each calculated by the evaluation function calculation unit 30 with respect to state transition when the energy value E2 calculated by the evaluation function calculation unit 64 becomes “0”. That is, the energy comparing unit 70 retains, as the minimum energy value Emin, the smallest energy value E1 among the energy values E1 each calculated by the evaluation function calculation unit 30 with respect to state transition when the energy value E2 calculated by the evaluation function calculation unit 64 indicates that no penalty is generated. The energy comparing unit 70 also retains a set of values of the state variables xᵢ when the minimum energy value Emin is obtained.

If the calculated energy value E2 with respect to the new state transition (at the current state s) calculated by the evaluation function calculation unit 64 indicates that penalty is not generated (when E2=0), the energy comparing unit 70 determines whether or not the retained minimum energy value Emin is to be updated. For example, based on comparison between the energy value E1 with respect to the new state transition (at the current state s) calculated by the evaluation function calculation unit 30 and the retained minimum energy value Emin, the energy comparing unit 70 determines whether or not the retained minimum energy value Emin is to be updated.

If the calculated energy value E2 with respect to the new state transition (at the current state s) calculated by the evaluation function calculation unit 64 indicates that penalty is generated (when E2 is not 0), the energy comparing unit 70 does not update the minimum energy value Emin retained by the energy comparing unit 70.

When optimization of the values of the state variables xᵢ using the evaluation function E1(x) is terminated, the energy comparing unit 70 outputs the retained minimum energy value Emin and the set of the state variables xᵢ when the retained minimum energy value Emin is obtained.

As described above, in a case in which the current state s satisfies a constraint, the optimization apparatus 14 determines whether the retained minimum energy value Emin is to be updated or not, by comparing the calculated energy value E1 at the current state s with the retained minimum energy value Emin. That is, a solution not satisfying a constraint is excluded from an object for the comparison. Therefore, the optimization apparatus 14 can further suppress outputting the solution not satisfying a constraint as an optimal solution.

The optimization apparatus 14 and the method of controlling the optimization apparatus 14 are not limited to the example illustrated in FIG. 6. For example, a determination as to whether or not the calculated energy value E2 at the current state s indicates that penalty is not generated (whether E2 is 0 or not) may be performed by the energy comparing unit 70.

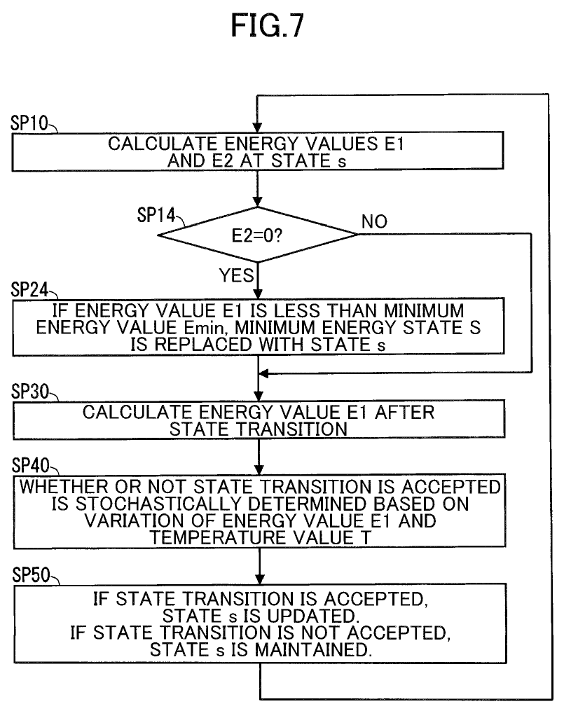

FIG. 7 is a flowchart illustrating an example of an operation of the optimization apparatus 14 illustrated in FIG. 6. The operation illustrated in FIG. 7 is an example of the method of controlling the optimization apparatus 14. For example, after initial values of the state variables x included in the evaluation functions E1(x) and E2(x) are given, the optimization apparatus 12 repeats execution of a series of steps from step SP10 to step SP50 for a predetermined number of times. After the series of steps from step SP10 to step SP50 are executed for the predetermined number of times, the optimization apparatus 14 outputs the minimum energy value Emin (the smallest energy value E1) and the minimum energy state S which are retained by the energy comparing unit 70.

The operation illustrated in FIG. 7 is the same as or similar to the operation illustrated in FIG. 5, except that step SP14 and step SP24 are executed in the operation illustrated in FIG. 7 instead of step SP12 and step SP20 in FIG. 5. With respect to steps in FIG. 7 which are the same as (or similar to) the steps in FIG. 5, the same or similar reference symbol are attached, and detailed description of these steps are omitted.

At step SP10, the evaluation function calculation unit 30 calculates the energy value E1 of the evaluation function E1(x) at the current state s received from the state retention unit 20, and the evaluation function calculation unit 64 calculates the energy value E2 of the evaluation function E2(x) at the current state s received from the state retention unit 20.

Next, at step SP14, the evaluation function calculation unit 64 determines if the energy value E2 calculated at step SP10 is “0”. That is, the evaluation function calculation unit 64 determines if the energy value E2 calculated at step SP10 indicates that penalty is not generated. If the energy value E2 is “0”, that is, if the energy value E2 indicates that penalty is not generated, the operation of the optimization apparatus 12 proceeds to step SP24. Conversely, if the energy value E2 is not “0”, that is, if the energy value E2 indicates that penalty is generated, the operation of the optimization apparatus 12 proceeds to step SP30. That is, if the energy value E2 is not “0”, a process at step SP24 for replacing the minimum energy state S with the current state s is not performed.

At step SP24, if the energy value E1 calculated at step SP10 is less than the minimum energy value Emin, the evaluation function calculation unit 64 replaces the minimum energy state S with the state s. The evaluation function calculation unit 64 also replaces the minimum energy value Emin with the energy value E1 calculated at step SP10. After step SP24, the operation of the optimization apparatus 14 proceeds to step SP30.

At step SP30, the evaluation function calculation unit 30 calculates the energy value E1 when state transition occurs, in which one of the state variables xᵢ is changed from the current state s.

Next, at step SP40, based on a variation of the energy value E1 (a difference between the energy value E1 calculated at step SP10 and the energy value E1 calculated at step SP30) and the temperature value T, the transition control unit 40 stochastically determines whether the state transition is to be accepted or not.

Next, at step SP50, if it is determined at step SP40 that the state transition is to be accepted, the state retention unit 20 updates the current state s into a new state s which is used for calculating the energy value E1 with respect to the state transition (values of the state variables xᵢ used at step SP30). If it is determined at step SP40 that the state transition is not accepted, the state retention unit 20 maintains the current state s, without performing the update. The state retention unit 20 also outputs the current state s to the evaluation function calculation unit 30 and the evaluation function calculation unit 64. After step SP50 is executed, the operation reverts to step SP10, and the optimization apparatus 14 repeats the execution of the series of steps from step SP10 to step SP50.

The operation of the optimization apparatus 14 is not limited to the example illustrated in FIG. 7. For example, the determination at step SP14 may be performed by the energy comparing unit 70. Further, for example, if the state s was not updated at step SP50 and the current state s is maintained, execution of step SP10, step SP14, and step SP24 at a next loop may be omitted. Further, if the state s was updated at step SP50, when step SP10 is to be executed at a next loop, calculation of the energy value E1 at the (current) state s may be omitted. Instead, the energy value E1 calculated at step SP30 at a previous loop may be used as the energy value E1 at the (current) state s.

As described above, in the present embodiment described with reference to FIGS. 6 and 7, a similar effect to the embodiment described with reference to FIGS. 4 and 5 can be obtained. That is, the optimization apparatus 14 encourages state transition by accepting transition to a solution which has energy close to an optimal solution but which does not satisfy a constraint, and can suppress outputting the solution not satisfying a constraint as an optimal solution. For example, the optimization apparatus 14 uses the evaluation function E1(x) in order to search for solutions of a combinatorial optimization problem, and uses the evaluation function E2(x) different from E1(x) in order to determine a minimum energy state S. If the energy value E2 at the current state s which is calculated based on the evaluation function E2(x) indicates that no penalty is generated (when E2=0), the optimization apparatus 14 determines whether the minimum energy value Emin is to be updated or not. That is, if the current state s satisfies the constraint, the optimization apparatus 14 determines whether the minimum energy value Emin is to be updated or not, by comparing the energy value E1 calculated at the current state s with the minimum energy value Emin before transiting to the current state s. Accordingly, because a solution not satisfying the constraint is excluded from an object for the comparison, the optimization apparatus 14 can further suppress outputting the solution not satisfying the constraint as an optimal solution.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

Each functional element in the optimization apparatus according to the above described embodiments, such as the state retention unit, the evaluation function calculation unit, the transition control unit, the temperature control unit, the evaluation function calculation unit, and the energy comparing unit, may be implemented by software or hardware. That is, the functional elements may be embodied by a CPU (Central Processing Unit) in the information processing apparatus executing software (computer program) stored in a memory of the information processing apparatus. Alternatively, the functional elements may be implemented by a dedicated hardware element, such as an FPGA (Field Programmable Gate Array) or an ASIC (Application Specific Integrated Circuit). Further, a portion of any of the functional elements may be implemented by software and another portion of said any of the functional elements may be implemented by hardware.

What is claimed is:

1. An optimization apparatus comprising:
a state retention unit configured to retain state variables for a first evaluation function and a second evaluation function each representing energy, the first evaluation function including a first penalty coefficient and the second evaluation function including a second penalty coefficient larger than the first penalty coefficient;
a first evaluation function calculation unit configured to calculate an energy value of the first evaluation function after a state transition in which a value of one of the state variables is changed;
a temperature control unit configured to control a temperature value;
a transition control unit configured to stochastically determine whether or not the state transition is to be accepted, based on the temperature value, a variation of the energy value of the first evaluation function, and a random number;
a second evaluation function calculation unit configured to calculate an energy value of the second evaluation function after the state transition; and
an energy comparing unit configured to output a minimum energy value of the energy value of the first evaluation function and values of the state variables when the minimum energy value is obtained by the first evaluation function, by comparing the energy value of the first evaluation function after the state transition with an energy value of the first evaluation function before the state transition, or to output a minimum energy value of the energy value of the second evaluation function and values of the state variables when the minimum energy value is obtained by the second evaluation function, by comparing the energy value of the second evaluation function after the state transition with an energy value of the second evaluation function before the state transition.

2. The optimization apparatus according to claim 1, wherein the energy comparing unit is configured to
retain a smallest energy value having been calculated by the second evaluation function as the minimum energy value, and a minimum state which is a set of values of the state variables when the smallest energy value was obtained;
determine whether or not the minimum energy value is to be updated, by comparing the value of the second evaluation function after a new state transition, with the retained minimum energy value; and
output the minimum energy value and the minimum state when an optimization of the state variables by the first evaluation function is terminated.

3. The optimization apparatus according to claim 2, wherein the energy comparing unit is configured
to determine whether or not the minimum energy value is to be updated, when the energy value of the first evaluation function after the new state transition becomes equal to the energy value of the second evaluation function after the new state transition; and
to omit updating the minimum energy value, when the energy value of the first evaluation function after the new state transition becomes different from the energy value of the second evaluation function after the new state transition.

4. The optimization apparatus according to claim 1, wherein the energy value calculated by the second evaluation function indicates presence or absence of penalty; and the energy comparing unit is configured to
retain, as the minimum energy value, a smallest energy value among energy values which have been calculated by the first evaluation function with respect to a specific set of state transitions with respect to which the energy value calculated by the second evaluation function indicates absence of penalty, and a minimum state which is a set of values of the state variables when the minimum energy value was obtained;
determine, when the energy value calculated by the second evaluation function with respect to a new state transition indicates absence of penalty, whether or not the minimum energy value is to be updated, by comparing the value of the first evaluation function with respect to the new state transition, with the minimum energy value;
omit updating the minimum energy value, when the energy value calculated by the second evaluation function with respect to the new state transition indicates presence of penalty; and
output the minimum energy value and the minimum state when an optimization of the state variables by the first evaluation function is terminated.

5. A method of controlling an optimization apparatus including a state retention unit, a first evaluation function calculation unit, a temperature control unit, a transition control unit, a second evaluation function calculation unit, and an energy comparing unit, the method comprising:
retaining, by the state retention unit, state variables for a first evaluation function and a second evaluation function each representing energy, the first evaluation function including a first penalty coefficient and the second evaluation function including a second penalty coefficient larger than the first penalty coefficient;
calculating, by the first evaluation function calculation unit, an energy value of the first evaluation function after a state transition in which a value of one of the state variables is changed;
controlling a temperature value by the temperature control unit;
stochastically determining, by the transition control unit, whether or not the state transition is to be accepted, based on the temperature value, a variation of the energy value of the first evaluation function, and a random number;
calculating, by the second evaluation function calculation unit, an energy value of the second evaluation function after the state transition; and
outputting, by the energy comparing unit, a minimum energy value of the energy value of the first evaluation function and values of the state variables when the minimum energy value is obtained by the first evaluation function, by comparing the energy value of the first evaluation function after the state transition with an energy value of the first evaluation function before the state transition, or a minimum energy value of the energy value of the second evaluation function and values of the state variables when the minimum energy value is obtained by the second evaluation function, by comparing the energy value of the second evaluation function after the state transition with an energy value of the second evaluation function before the state transition.
